(19) United States
(12) Patent Application Publication
(10) Pub. No.: US 2023/0106916 A1
(43) Pub. Date: Apr. 6, 2023

(54) METHOD FOR CHEMICALLY MODIFYING A WOOD PART

(71) Applicant: COMMISSARIAT Å L'ÉNERGIE ATOMIQUE ET AUX ÉNERGIES ALTERNATIVES, Paris (FR)

(72) Inventors: Pierre Piluso, Grenoble (FR); Nicolas Bedouin, Grenoble (FR); Jérôme Delmas, Grenoble (FR); Olivier Poncelet, Grenoble (FR); Isabelle Rougeaux, Grenoble (FR)

(21) Appl. No.: 17/904,620

(22) PCT Filed: Feb. 17, 2021
(86) PCT No.: PCT/FR2021/050273

§ 371 Date: Aug. 19, 2022

(30) Foreign Application Priority Data
Feb. 26, 2020 (FR) FR2001880

(51) Int. Cl. B27K 3/34; B27K 3/08

(52) U.S. Cl. CPC B27K 3/346; B27K 3/086; B27K 2240/30

(57) ABSTRACT

A method for chemically modifying a wood part comprising hydroxyl groups comprising: a first step of covalently reacting all or part of the hydroxyl groups with at least one non-polymeric compound comprising at least one group capable of covalently reacting with a hydroxyl group, whereby the wood part is thus covalently linked to residues of the non-polymeric compound(s); after or simultaneously with the first step, a second step of covalently reacting all or part of the residues of the non-polymeric compound(s) with at least one second compound, the first step and the second step being performed in the presence of at least one supercritical fluid.

### TECHNICAL FIELD

The present invention relates to a method for chemically modifying a wood part in a medium that allows chemical modification both on the surface and in the core of the wood part.

Depending on the nature of the chemical compound(s) chosen for the chemical modification, the method of the invention may impart a targeted property to the wood part that is not inherent to the part before chemical modification or may improve a targeted property of the wood constituting the part, the targeted properties may be chosen, in a non-exhaustive manner, from the following list: hydrophilicity, hydrophobicity, oleophobicity, dimensional stability, reduction of water absorption, mechanical properties, such as impact resistance, abrasion resistance, fire retardancy, aesthetic design (such as colouring, gloss), antibacterial, antifouling, adhesiveness or non-adhesiveness, electrical properties (such as electrical shielding), cleanability.

Conventionally, the properties of a wood part can be modified or improved by simply impregnating the part with one or more chemical agents to impart or improve the targeted property, but with the following drawback(s):
the impregnation only results in a surface treatment and does not allow the part to be reached in depth, the targeted property being thus only localised on the surface of the part;
the impregnation does not allow strong binding of the chemical agent(s), the targeted property imparted by this/these agent(s) not having a satisfactory resistance over time;
the chemical agent(s), due to their high molecular weight, cannot reach the core of the material, the targeted property imparted by this/these agent(s) thus only affecting the surface of the part.

In view of the above, the authors of the present invention have suggested to develop a method for chemically modifying a wood part which does not have the aforementioned drawbacks.

### DISCLOSURE OF THE INVENTION

Thus, the invention relates to a method for chemically modifying a wood part comprising hydroxyl groups comprising the following steps:
a first step of covalently reacting all or part of said hydroxyl groups with at least one non-polymeric compound, also called the first compound, comprising at least one group capable of covalently reacting with a hydroxyl group, whereby, at the end of this first reaction step, the wood part is thus covalently linked to residues of the non-polymeric compound(s);
after or simultaneously with said first step, a second step of covalently reacting all or part of the residues of the non-polymeric compound(s) with at least one second compound,

said first step and said second step being performed in the presence of at least one supercritical fluid.

By covalent reaction, it is set out that it is:
for the first step, a covalent linkage-forming reaction, this reaction occurring between all or part of the hydroxyl groups of the wood part and the groups of the non-polymeric compound(s) capable of covalently reacting with said hydroxyl groups, whereby this results in covalent links between the wood part and the non-polymeric compound(s) (the latter remaining as residues, that is, what remains of the non-polymeric compound(s) after reaction of the latter with hydroxyl groups of the wood part);
for the second step, a covalent linkage-forming reaction, this reaction occurring between all or part of the residue(s) of the non-polymeric compound(s) and the second compound(s), it being understood that the residue(s) and the second compound(s) respectively include groups capable of reacting covalently with each other.

By using at least one supercritical fluid to implement these steps, the following advantages have been noticed:
the possibility of driving firstly the non-polymeric compound(s) and secondly the second compound(s) into the depths of the part, and thus inducing a chemical modification of the part both on the surface and in the depths, and therefore in the whole part, so that the part can then be caused to be cut while exhibiting homogeneous chemical modification on the various pieces resulting from this cutting;
a high solvating power, which makes it possible to impart, to the reactions, a much faster reaction kinetics in comparison with similar reactions which would be conducted in a non-supercritical medium;
the possibility of performing said modification without the use of volatile organic solvent, the removal of which after the reaction would be both energy-intensive and time-consuming, and traces of which would be likely to be present in the parts treated;
the possibility of performing said modification while limiting amount of reagent and catalysts, if any, used and amount of residual reagent and catalysts in the wood parts in comparison with conventional impregnation methods.

Besides, the method of the invention may have the following advantages:
an easily industrialisable method including a small number of steps, generally not requiring large amounts of products (which is one advantage of using a supercritical fluid in comparison with liquid solvent immersion techniques) and allowing the simultaneous treatment of several parts;
no prior preparation of the surface of the parts to be treated;
the possibility of treating all the complex reliefs of the parts, if any.

By supercritical fluid, it is meant a fluid brought to a pressure and a temperature beyond its critical point, corresponding to the pair of temperature and pressure (Tc and Pc respectively), for which the liquid phase and the gaseous phase have the same density and beyond which the fluid is in its supercritical range. Under supercritical conditions, the fluid has a much higher dissolving power than the same fluid under non-supercritical conditions and thus facilitates solubilisation of the first and second compounds. It is understood that the supercritical fluid used is capable of solubilising the first and second compounds.

The supercritical fluid can advantageously be supercritical CO₂, especially because of its low critical temperature (31° C.), which makes it possible to implement the reaction at low temperature without risk of degradation of the first and second compounds. More precisely, supercritical CO₂ is obtained by heating carbon dioxide above its critical temperature (31° C.) and compressing it above its critical pressure (73 bar). Moreover, supercritical CO₂ is non-flammable, non-toxic, relatively cheap and does not require re-treatment at the end of the method, in comparison with methods involving the exclusive use of organic solvent, which also makes it a “green” solvent of industrial relevance. Finally, supercritical CO₂ has a good solvating power (adaptable depending on the pressure and temperature conditions used), a low viscosity and a high diffusivity. Finally, its gaseous nature under the ambient pressure and temperature conditions makes the steps of separating the thus modified part from the reaction medium (comprising, for example, unreacted compounds) and reusing the CO₂ easy to perform at the end of the reaction and once the CO₂ has returned to a non-supercritical state. All of the above conditions contribute to making supercritical CO₂ an excellent choice of solvent for carrying out the reaction steps of the method in accordance with the invention.

As mentioned above, the method according to the invention comprises a first step of covalently reacting all or part of said hydroxyl groups with at least one non-polymeric compound, also called the first compound, comprising at least one group (hereinafter called reactive group(s)) capable of covalently reacting with a hydroxyl group, whereby, at the end of this first reaction step, the wood part is thus covalently linked to residues of the non-polymeric compound(s).

By residues of the non-polymeric compound(s) it is meant what remains of the non-polymeric compound(s) after covalently reacting the latter with hydroxyl groups of the part.

The wood part to be treated in accordance with the method of the invention may be a part made of all types of wood species, including a part comprising several distinct types of wood species. In particular, the wood part may be made of one or more wood species selected from hardwoods, softwoods and mixtures thereof.

More specifically, the method of the invention is particularly adapted for the treatment of parts made of softwood(s), such as parts made of fir(s) or spruce(s), which have the feature of being difficult to treat by conventional impregnation techniques.

The non-polymeric compound(s) reacting covalently with the hydroxyl groups of the wood part via at least one reactive group are not polymers, that is compounds comprising a chain of repeating units, which enables them to gain easier access to the core of the wood part and to react covalently with the hydroxyl groups located in the core of the wood part.

The non-polymeric compound(s) used in the first covalent reaction step comprise at least one group capable of covalently reacting with a hydroxyl group of the wood part, which compound(s) may be selected from epoxy compounds, anhydride compounds, acyl halide compounds, carboxylic acid compounds, silyl ether compounds, isocyanate compounds and mixtures thereof.

As regards epoxy compounds, it is meant compounds comprising at least one epoxy group, the epoxy group being the reactive group which covalently reacts with a hydroxyl group under acidic or basic, preferably basic, conditions according to a nucleophilic ring-opening mechanism with the formation of an ether linkage between the wood part and the residue of the epoxy compound.

As regards anhydride compounds, it is meant compounds comprising at least one anhydride group, the anhydride group being the reactive group which covalently reacts with a hydroxyl group with the formation of an ester linkage between the wood part and the residue of the anhydride compound.

As regards acyl halide compounds, it is meant compounds comprising at least one acyl halide group (more specifically, at least one acyl chloride group), the acyl halide group being the reactive group which covalently reacts with a hydroxyl group with the formation of an ester linkage between the wood part and the residue of the acyl halide compound.

As regards carboxylic acid compounds, it is meant compounds comprising at least one carboxylic acid group, the carboxylic acid group being the reactive group which covalently reacts with a hydroxyl group with the formation of an ester linkage between the wood part and the residue of the carboxylic acid compound.

As regards silyl ether compounds, it is meant compounds comprising at least one silyl ether group, the silyl ether group being the reactive group which covalently reacts with a hydroxyl group with the formation of a silyl ether linkage between the wood part and the residue of the silyl ether compound.

As regards isocyanate compounds, it is meant compounds comprising at least one isocyanate group, the isocyanate group being the reactive group which covalently reacts with a hydroxyl group with the formation of a carbamate linkage between the wood part and the residue of the isocyanate compound.

Depending on the non-polymeric compound(s) selected, the person skilled in the art will choose operating parameters to allow the covalent reaction with the hydroxyl groups of the wood part, these operating parameters may be determined by preliminary tests.

Advantageously, the non-polymeric compound(s) are epoxy compounds, which allow the formation of an ether linkage with the wood part to be treated, this type of links being more stable than an ester linkage, which is likely to hydrolyse.

More specifically, the non-polymeric compound(s) are epoxy compounds, further comprising an epoxy group, at least one vinyl group, which vinyl group may subsequently react with another organic compound (hereinafter called the second compound) comprising a group capable of covalently reacting with the vinyl group.

By way of examples, the non-polymeric compound(s) may be a glycidyl (meth)acrylate compound, an allyl glycidyl ether compound, a 2-methyl-2-vinyloxirane compound or a 1,2-epoxy-9-decene compound.

When the non-polymeric compound is a glycidyl methacrylate compound, the reaction of this compound with a hydroxyl group of a wood part can be depicted by the following chemical equation:

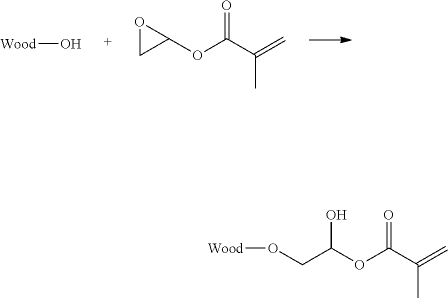

the residue of the glycidyl methacrylate compound thus having the formula —CH₂—CH(OH)—O—CO—C(CH₃)═CH₂.

Furthermore, the first reaction step may be performed in the presence of at least one cosolvent, which may improve solubility of the non-polymeric compound(s) and/or improve swelling of the wood and thereby facilitate access of the non-polymeric compound(s) to the core of the wood part.

Furthermore, the first reaction step may be performed in the presence of at least one catalyst.

By way of example, when the non-polymeric compound is a compound comprising at least one epoxy group, the cosolvent may be a ketone solvent, such as acetone and the catalyst may be a basic compound, such as a tertiary amine, such as triethylamine.

More specifically, the first reaction step may include the following operations:
an operation of placing, in a reactor, the wood part, at least one non-polymeric compound, optionally at least one cosolvent and optionally at least one catalyst;
an operation of introducing CO₂ into the reactor;
an operation of pressurising and heating the reactor to a temperature higher than the critical temperature of the CO₂ and to a pressure higher than the critical pressure of the CO₂, this temperature and this pressure being maintained until the reaction is completed.

In one alternative, the operation of pressurising and heating the reactor may be sequenced as follows:
an operation of pressurising and heating the reactor to a temperature higher than the critical temperature of the CO₂ and to a pressure higher than the critical pressure of the CO₂, the temperature and pressure being chosen to generate an impregnation without reaction of the wood part with the non-polymeric compound(s), followed by an optional precipitation of the non-polymeric compound(s);
an operation of increasing pressure and temperature, the temperature and the pressure being set so as to allow covalent reaction of the non-polymeric compound(s) with the wood part, this temperature and this pressure being maintained until said reaction is completed,

this sequence of operations may be repeated once or more.

Advantageously, the placement operation may be carried out so that there is no direct contact between the wood part and the non-polymeric compound(s), the optional catalyst and the optional cosolvent.

At the end of the first reaction step, the wood parts are thus covalently linked to (or covalently grafted by) residues of the non-polymeric compound(s), that is what remains of the non-polymeric compound(s) after covalent reaction thereof with hydroxyl groups of the wood part.

After the first reaction step, the supercritical conditions may be removed by depressurising the reactor, prior to starting the second covalent reaction step, when this is implemented after the first step, this second covalent reaction step itself being performed in the presence of at least one supercritical fluid.

The wood part thus modified may then be subjected to drying, for example, under vacuum, before starting the second covalent reaction step.

The method of the invention comprises, after or simultaneously with the above-mentioned first reaction step (preferably after the above-mentioned first reaction step), a second step of covalently reacting all or part of the residue(s) of the non-polymeric compound(s) with at least one second compound, which implies, of course, in this case that the residue(s) of the non-polymeric compound(s) covalently linked to the wood part comprise at least one group capable of covalently reacting with a group of the second compound(s). The second compound(s) are preferably non-polymeric compounds.

By way of example, the residue(s) may, as a group or groups capable of reacting with at least one group of the second compound(s), comprise at least one vinyl group and, in turn, the second compound(s) may comprise, as a group capable of reacting with a vinyl group of the residue(s), also at least one vinyl group. In this case, the second covalent reaction step may consist of a step of polymerising the second compound(s) initiated from the above-mentioned residue(s), and more specifically a step of polymerising the second compound(s) comprising at least one vinyl group, the polymerisation thus propagating from the residues of the functional compound via the vinyl groups thereof. At the end of this step, a modified wood part remains, linked to grafts consisting of polymeric chains resulting from the polymerisation of the second compound(s), the linkage between the wood part and the grafts being made via the residues of the non-polymeric compound(s) which form organic spacer groups between the wood part and the grafts, these residues being covalently linked to the wood part, on the one hand, and covalently linked to the above-mentioned grafts on the other hand. In this case, the residues are what remains of the non-polymeric compound(s) after reaction of the latter, on the one hand, with the hydroxyl groups of the wood part and, on the other hand, with the vinyl group(s) of the second compound(s).

More specifically, in this case, the method of the invention can be defined as a method for modifying a wood part comprising hydroxyl groups comprising successively:
as a first step, a first step of covalently reacting all or part of said hydroxyl groups of the wood part with at least one non-polymeric compound, also called the first compound, comprising at least one group capable of covalently reacting with a hydroxyl group and comprising at least one vinyl group, whereby, at the end of this first reaction step, the wood part is thus covalently linked to residues of the non-polymeric compound(s);
as a second step, from the vinyl groups of the residues of the non-polymeric compound(s), a step of polymerising a second compound comprising at least one vinyl group,

said first step and said second step being performed in the presence of at least one supercritical fluid.

Besides, the second compound(s) may advantageously comprise at least one group capable of imparting a particular targeted property to the wood part, such as a property selected from the following properties: hydrophilicity, hydrophobicity, oleophobicity, dimensional stability, reduction of water absorption, mechanical properties, such as impact resistance, abrasion resistance, fire retardancy, aesthetic design (such as colouring, gloss), antibacterial, antifouling, adhesiveness or non-adhesiveness, electrical properties (such as electrical shielding), cleanability. In this case, the second compound(s) can thus be referred to as organic compounds of interest.

By organic compound of interest, it is meant a compound comprising at least one group capable of imparting or improving a given property to the wood part, called the functional group of interest.

More specifically, the second compound(s) may further comprise at least one group capable of imparting or improving a given property to the wood part, called the functional group of interest, such as at least one group comprising at least one phosphorus atom, such as a phosphate group or a phosphonate group to impart fire retardant properties to the wood part.

By way of examples, the second compound(s) may be selected from bis[2-(methacryloyloxy)ethyl]phosphate, diethylallylphosphate, diethylallylphosphonate, dimethylvinylphosphonate, diethylvinylphosphonate and mixtures thereof.

This second reaction step may be performed in the presence of a cosolvent and/or a catalyst, such as a free radical initiator (such as AIBN), especially when the second compound(s) include at least one vinyl group to be reacted with a vinyl group of the residue(s) of the non-polymeric compound(s).

A specific method in accordance with the invention is a method wherein:
the first covalent reaction step is a step of covalently reacting all or part of said hydroxyl groups with a first compound comprising at least one epoxy group and at least one vinyl group, for example glycidyl methacrylate, in the presence of supercritical CO₂, the epoxy groups covalently reacting with all or part of the hydroxyl groups, whereby, at the end of this first reaction step, the wood part is thus covalently linked to residues of the first compound;
the second covalent reaction step is a step of polymerising a second compound comprising at least one vinyl group and at least one functional group of interest, such as a phosphate group or a phosphonate group, for example, bis[2-(methacryloyloxy)ethyl]phosphate, in the presence of supercritical CO₂, the polymerisation being initiated from the vinyl groups of the residues of the first compound.

More specifically, the step of reacting the wood part with a second compound may include the following operations:
an operation of placing, in a reactor, the wood part having reacted with the non-polymeric compound(s), at least one second compound, optionally at least one cosolvent and optionally at least one catalyst;
an operation of introducing CO₂ into the reactor;
an operation of pressurising and heating the reactor to a temperature higher than the critical temperature of the CO₂ and to a pressure higher than the critical pressure of the CO₂, this temperature and this pressure being maintained until the reaction is completed.

Alternatively, the operation of pressurising and heating the reactor may be sequenced as follows:
an operation of pressurising and heating the reactor to a temperature higher than the critical temperature of the CO₂ and to a pressure higher than the critical pressure of the CO₂, the temperature and the pressure being chosen to generate an impregnation without reaction of the wood part with the second compound(s) followed by an optional precipitation of the non-polymeric compound(s);
an operation of increasing pressure and temperature, the temperature and the pressure being set so as to allow the covalent reaction of the second compound(s) with the residue(s) of the non-polymeric compound(s) covalently linked to the wood part, this temperature and this pressure being maintained until said reaction is completed, this sequence of operations may be repeated once or more.

Advantageously, the placement operation can be carried out so that there is no direct contact between the wood part and the second compound(s), the optional catalyst and the optional cosolvent.

After implementing the second reaction step, the method typically includes a step of stopping the supercritical conditions and optionally a step of drying the modified wood part.

Whatever the embodiments, the modification method may be considered, in particular, as a method capable of imparting or improving a given property of the wood part and, in particular, of imparting fire retardant properties, in which case the method of the invention is a method for treating the wood part with fire retardant.

The method of the invention may be implemented in a device, for example, of the autoclave type, comprising a chamber to receive the wood part, the reagents, the supercritical fluid, the optional cosolvent and the optional catalyst, means for regulating pressure of said chamber for vacuumising the same (for example, via a vacuum pump communicating with the chamber) and heating means.

Further advantages and characteristics of the invention will become apparent from the non-limiting detailed description below.

### BRIEF DESCRIPTION OF THE DRAWINGS

FIG. 1 illustrates a photograph of the slice of wood (point a) corresponding to the edge of the specimen, point c) to the core of the specimen and point b) to an interspace between the edge and the core) obtained in accordance with the example below.

FIG. 2 illustrates IR-ATR spectra of wood samples obtained in accordance with the example below.

FIG. 3 illustrates IR-ATR spectra of wood samples obtained in accordance with the example below.

### DETAILED DESCRIPTION OF PREFERRED EMBODIMENTS

### Example

This example illustrates the implementation of a specific mode of the chemical modification method of the invention which comprises a chemical modification in two steps:

1) a step of reacting spruce wood parts, which are spruce specimens, with glycidyl methacrylate (referred to below as GMA);

2) a step of reacting the thus modified parts with a phosphorus compound: bis[2-(methacryloyloxy)ethyl]phosphate (referred to below as BMEP),

these two steps being performed under supercritical CO₂ in a specific reactor.

The simplified reaction scheme for these two reactions can be as follows:

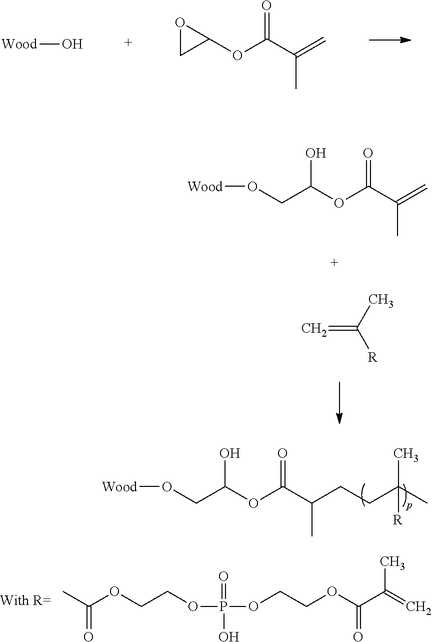

Wood-OH corresponding to the wood part, with only one —OH group represented for the sake of simplification and p corresponding to the number of repeats of the repeating unit in brackets.

The specific reactor mentioned above is a 600 mL stainless steel batch type reactor with an outer heating system. The reagents (GMA, BMEP), catalysts and solvents (acetone) are deposited in a 70 mL crystalliser placed at the bottom of the reactor. The wood specimens are placed on the edges of the crystalliser to ensure that there is no direct contact between the reagents, catalysts and solvent on the one hand and the wood on the other. The CO₂ is introduced into the reactor, slightly preheated above 31° C., with a double piston pump whose heads are cooled to a temperature below 5° C. to have CO₂ in the liquid phase in the tubes and avoid cavitation problems. In the reactor, however, the CO₂ is never present in the liquid state.

The wood parts are spruce specimens with dimensions 65*20*24 cm, the wood grain being in the direction of the last dimension and weighing, once dried for 1 hour at 103° C., from 13 to 14 g.

1) Step of Reacting Spruce Specimens with GMA

For this purpose, two spruce specimens previously dried for one hour at 103° C. and meeting the above-mentioned specificities were placed, as described above, in the reactor above the crystalliser containing 27 mL of GMA and 27 mL of acetone. The aim of the acetone added to the reaction medium is to prevent self-polymerisation of the GMA in the crystalliser. 2.7 mL of triethylamine was placed in a separate crystalliser in the reactor. CO₂ was introduced and the reactor was then placed under 200 bar and 140° C. to form supercritical CO₂, these conditions being maintained for 7 hours.

After depressurisation, the wood specimens were recovered and dried in a vacuum oven at 103° C. overnight. The weight percentage gain (WPG) of the specimens was 22.1 and 22.0% (relative to the dry mass before treatment), and the longitudinal swelling of the specimens after one day's immersion in water was reduced by 60.1 and 56.2% respectively.

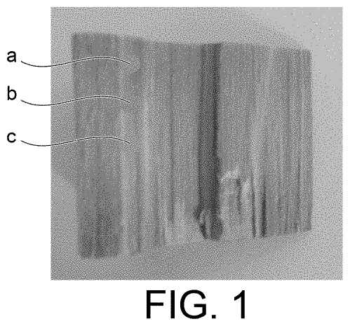

One of the wood specimens was partially cut for analysis by attenuated total reflectance infrared spectroscopy (ATR-IR), the places where the spectroscopy was performed being represented in FIG. 1 which illustrates a photograph of the slice of wood (point a) corresponding to the edge of the specimen, point c) to the core of the specimen and point b) to an interspace between the edge and the core).

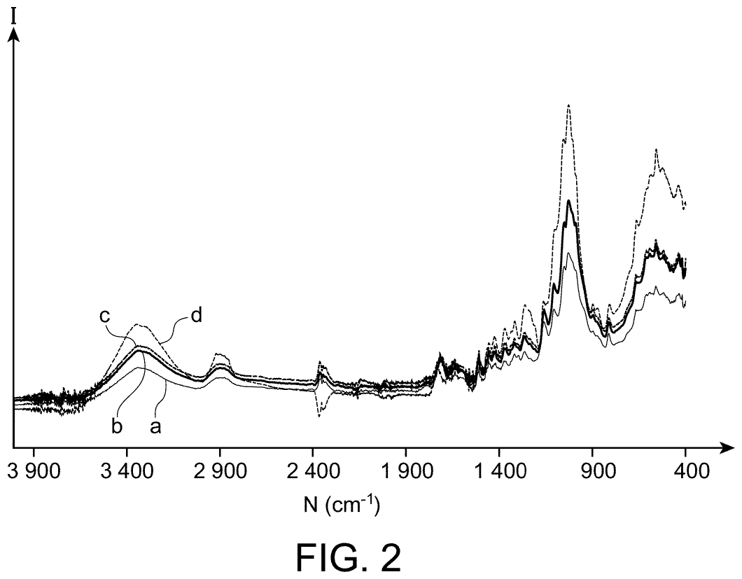

The IR-ATR spectra of unmodified wood (curve d)) and GMA-modified wood (curve a) for the edge, curve b) for the interspace and curve c) for the core) are illustrated in the appended FIG. 2, with the ordinate representing intensity I of the peaks and the abscissa the wave number N (in cm⁻¹).

An increase in the intensity of the peak at 1710 cm⁻¹ corresponding to C═O bonds (especially GMA ester) is observed with the modification by GMA and the depth of analysis in the wood (in the direction of the wood grain). The more the wood is modified, the higher the peak in comparison for example with the peak at 1620 cm′ which corresponds to the aromatic C═C bonds of the lignin (not affected by the modification). It is observed from these spectra that the modification has been carried out to the core of the wood and that a gradient of modification is observed between outside (which is more strongly modified) and the core.

2) Step of Reacting the Thus Modified Specimens with BMEP

The specimens thus modified in the previous step were treated under supercritical CO₂ with bis[2-(methacryloyloxy)ethyl] phosphate (BMEP) in the presence of a free radical initiator: α,α′-AzoBisobutyronitrile (AIBN).

For this purpose, 5 mL of BMEP and 20 mL of acetone are placed in the crystalliser of the reactor defined above. 0.2 mg of AIBN is deposited at the bottom of the reactor outside the crystalliser. The GMA-modified wood specimens are then placed above the crystalliser without contact with the liquid or the AIBN. The reactor is closed and CO₂ is introduced and the treatment is applied in 2 phases with a first impregnation phase at 40° C., 100 bar for 5 hours followed by a reaction phase at 110° C. and 220 bar for 2 hours.

The specimens are then recovered and dried in a vacuum oven overnight.

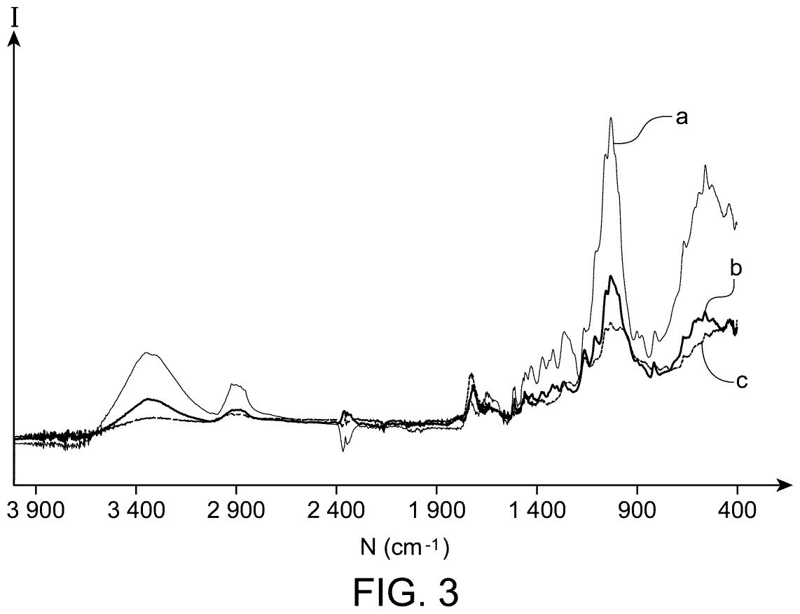

One of the wood samples was subjected to an analysis of its edge by attenuated total reflectance infrared spectroscopy (IR-ATR), the IR-ATR spectra of the unmodified wood (curve a)), of the wood modified by GMA only (curve b) for the edge) and of the wood modified by GMA and BMEP (curve c)) are represented in the appended FIG. 3, the ordinate representing intensity I of the peaks and the abscissa the wave number N (in cm⁻¹).

On curve c), the presence of BMEP clearly appears, especially with the increase in the intensity of the peaks at 983 cm′ (P—O—C bond) and at 1720 cm′ (C═O bond of the BMEP acrylate), thus validating the system described by the invention, which makes it possible to provide functionality via a pre-grafting of a vinyl compound.

What is claimed is:

1.-17. (canceled)

18. A method for chemically modifying a wood part comprising hydroxyl groups comprising the following steps:
a first step of covalently reacting all or part of said hydroxyl groups with at least one non-polymeric compound, called the first compound, comprising at least one group capable of covalently reacting with a hydroxyl group, whereby, at the end of this first reaction step, the wood part is thus covalently linked to residues of the non-polymeric compound(s);
after or simultaneously with said first step, a second step of covalently reacting all or part of the residues of the non-polymeric compound(s) with at least one second compound,
said first step and said second step being performed in the presence of at least one supercritical fluid.

19. The method according to claim 18, wherein the supercritical fluid is supercritical CO₂.

20. The method according to claim 18, wherein the wood part is made of one or more wood species selected from hardwoods, softwoods and mixtures thereof.

21. The method according to claim 18, wherein the wood part is a part of softwood(s).

22. The method according to claim 18, wherein the non-polymeric compound(s) is (are) selected from epoxy compounds, anhydride compounds, acyl halide compounds, carboxylic acid compounds, silyl ether compounds, isocyanate compounds and mixtures thereof.

23. The method according to claim 18, wherein the non-polymeric compound(s) is (are) epoxy compounds.

24. The method according to claim 18, wherein the non-polymeric compound(s) is (are) epoxy compounds comprising at least one vinyl group.

25. The method according to claim 18, wherein the first reaction step is performed in the presence of at least one cosolvent.

26. The method according to claim 18, wherein the first reaction step includes the following operations:
an operation of placing, in a reactor, the wood part, at least one non-polymeric compound, optionally at least one cosolvent and optionally at least one catalyst
an operation of introducing CO₂ into the reactor;
an operation of pressurising and heating the reactor to a temperature higher than the critical temperature of the CO₂ and to a pressure higher than the critical pressure of the CO₂, this temperature and this pressure being maintained until the reaction is completed.

27. The method according to claim 18, wherein the residue(s) comprise(s), as group(s) capable of reacting with at least one group of the second compound(s), at least one vinyl group.

28. The method according to claim 18, wherein the second compound(s) comprise(s) at least one group capable of imparting a given property to the wood part or improving a given property of the wood part, called the functional group of interest.

29. The method according to claim 28, wherein the second compound(s) include, as a functional group of interest, at least one group comprising at least one phosphorus atom, such as a phosphate group or a phosphonate group.

30. The method according to claim 27, wherein the second compound(s) comprise(s) at least one vinyl group.

31. The method according to claim 18, comprising successively the following steps:
as a first step, a first step of covalently reacting all or part of said hydroxyl groups of the wood part with at least one non-polymeric compound, called the first compound, comprising at least one group capable of covalently reacting with a hydroxyl group and comprising at least one vinyl group, whereby, at the end of this first reaction step, the wood part is thus covalently linked to residues of the non-polymeric compound(s);
as a second step, from the vinyl groups of the residues of the non-polymeric compound(s), a step of polymerising a second compound comprising at least one vinyl group,
said first step and said second step being performed in the presence of at least one supercritical fluid.

32. The method according to claim 31, wherein:
the first covalent reaction step is a step of covalently reacting all or part of said hydroxyl groups with a first compound comprising at least one epoxy group and at least one vinyl group, in the presence of supercritical CO₂, the epoxy groups covalently reacting with all or part of the hydroxyl groups, whereby, at the end of this first reaction step, the wood part is thus covalently linked to residues of the first compound;
the second covalent reaction step is a step of polymerising a second compound comprising at least one vinyl group and at least one functional group of interest, such as a phosphate group, in the presence of supercritical CO₂, the polymerisation being initiated from the vinyl groups of the residues of the first compound.

33. The method according to claim 18, which is a method capable of imparting or improving a given property of the wood part.

34. The method according to claim 18, which is a method for treating the wood part with fire retardant.
